(19) United States
(12) Patent Application Publication
(10) Pub. No.: US 2007/0003095 A1
(43) Pub. Date: Jan. 4, 2007

(54) Porous solid wind screen for microphone

(76) Inventors: Milan Slamka, Camas, WA (US); Zlatan Ribic, Vienna (AT); Michael Howes, Vancouver, WA (US); Todd Yuzuriha, Vancouver, WA (US); Steve Jensen, Camas, WA (US)

Correspondence Address: IPSOLON LLP, 111 SW COLUMBIA, SUITE 710, PORTLAND, OR, 97201, US

(21) Appl. No.: 11/218,914

(22) Filed: Sep. 1, 2005

Related U.S. Application Data
(63) Continuation of application No. 11/031,694, filed on Jan. 7, 2005, now abandoned.
(60) Provisional application No. 60/535,055, filed on Jan. 7, 2004.

(51) Int. Cl. H04R 25/00

(52) U.S. Cl. 381/381

(57) ABSTRACT

A porous solid windscreen formed of metal, plastic or the like covers the microphone without the need for the familiar large foam ball of material over the microphone. In a disclosed embodiment, the windscreen is a monolithic structure formed by sintering the material so as to produce a relatively consistent and desired sized pore structure. The wind screen is preferably sintered while in a mold, thereby allowing it to be formed in a variety of form factors including substantially arcuate structures or non-symmetrical structures and the like to accommodate desired aesthetic and/or acoustic needs.

### CROSS-REFERENCE TO RELATED APPLICATIONS

This application is a continuation of U.S. patent application Ser. No. 11/031,694, filed on Jan. 7, 2005, now pending, and it claims priority to U.S. Provisional Patent Application Ser. No. 60/535,055 filed on Jan. 7, 2004, the disclosure of which is hereby incorporated by reference.

### FIELD OF THE INVENTION

The present invention relates to a personal audio set that includes a porous solid windscreen operably secured thereto.

### BACKGROUND OF THE INVENTION

Personal audio-sets, commonly known as headphones, earphones, headsets, and the like, are gaining in popularity. The typical audio-set includes a frame containing an earphone which is usually positioned over or in a wearer's ear. In cases where the audio-set is a headset, a microphone is also typically positioned on the frame near the wearer's mouth.

Most headsets today either offer no wind or pop protection for the microphone, or they rely on foam based windscreens/pop screens. As headset designs have evolved into smaller form factors, the amount of foam required to effectively shield a microphone of a headset from wind often is too great to accommodate a desired smaller form factor. Accordingly, most small headsets either provide none or too little wind and/or pop protection for the microphone, or they place a much larger foam screen over a microphone thereby compromising the aesthetic look of the structure.

### SUMMARY OF THE INVENTION

Accordingly, despite the available improvements offered by personal audio-set ear mounts, there remains a need for a personal audio set having a mechanical, cost effect, light weight, non-bulky, non-foam wind or pop screen attached thereto. In addition to other benefits that will become apparent in the following disclosure, the present invention fulfills these needs.

The present invention is a porous solid windscreen formed of metal, plastic or the like covers the microphone without the need for the familiar large foam ball of material over the microphone. Preferably, the windscreen is a monolithic structure formed by sintering the material so as to produce a relatively consistent and desired sized pore structure. More preferably, the wind screen is sintered while in a mold, thereby allowing it to be formed in a variety of form factors including substantially arcuate structures or non-symmetrical structures and the like to accommodate desired aesthetic and/or acoustic needs.

### BRIEF DESCRIPTION OF THE DRAWINGS

FIG. 1 is a bottom, left side, isometric view of a personal audio set having a porous solid wind screen operably secured thereto in accordance with an embodiment of the present invention.

FIG. 2 is a top, right side, isometric view of the personal audio set of FIG. 1 showing a possible sliding movement of the hear hook about pivot axis A in the direction of arrows A1 and a possible pivoting movement of the hear hook about axis B in the direction of arrow B1.

FIG. 3 is a left side view of the headset of FIG. 1 showing a possible installation on a user's left ear.

FIG. 4 is a back view of the headset of FIG. 1.

FIG. 5 is a front view of the headset of FIG. 1.

FIG. 6 is a right side view of the headset of FIG. 1.

FIG. 7 is a top view of the headset of FIG. 1.

FIG. 8 is a sectional view of the headset of FIG. 1 taken along line 8-8 of FIG. 4.

FIG. 9 is an exploded isometric view of the headset of FIG. 1.

FIG. 10 is a sectional view of the headset of FIG. 1 taken along line 10-10 of FIG. 11F.

FIGS. 11A-E are various sectional views of portions of the headset of FIG. 1.

FIGS. 12A-D are various isometric views showing possible movement of the ear clip relative to the headset frame in accordance with an embodiment of the present invention.

FIG. 13 is a right side view of an alternative embodiment headset having a porous solid windscreen operably secured thereto.

FIG. 14 is a top, right side isometric view of the headset of FIG. 13.

FIG. 15A is an isometric view of a spine portion of an ear hook in accordance with an embodiment of the present invention.

FIG. 15B is an isometric view of an over-molded portion of an ear hook in accordance with an embodiment of the present invention.

FIG. 15C is the spine and over-molded portions of the ear hook of FIGS. 15A and 15B showing a possible assembled configuration.

FIG. 16 is an exploded isometric view of the headset of FIG. 13.

FIG. 17 in an enlarged cross-sectional view of a possible attachment structure for pivotally securing the ear hook to the frame.

FIG. 17A is an enlarged, partial, cross-sectional view of the attachment structure of FIG. 17.

FIG. 18 is a cross-sectional view of the headset of FIG. 13 taken along line 18-18 of FIG. 17.

FIG. 19 is an enlarged isometric view of a portion of the attachment structure of FIG. 17.

### DETAILED DESCRIPTION OF PREFERRED EMBODIMENTS

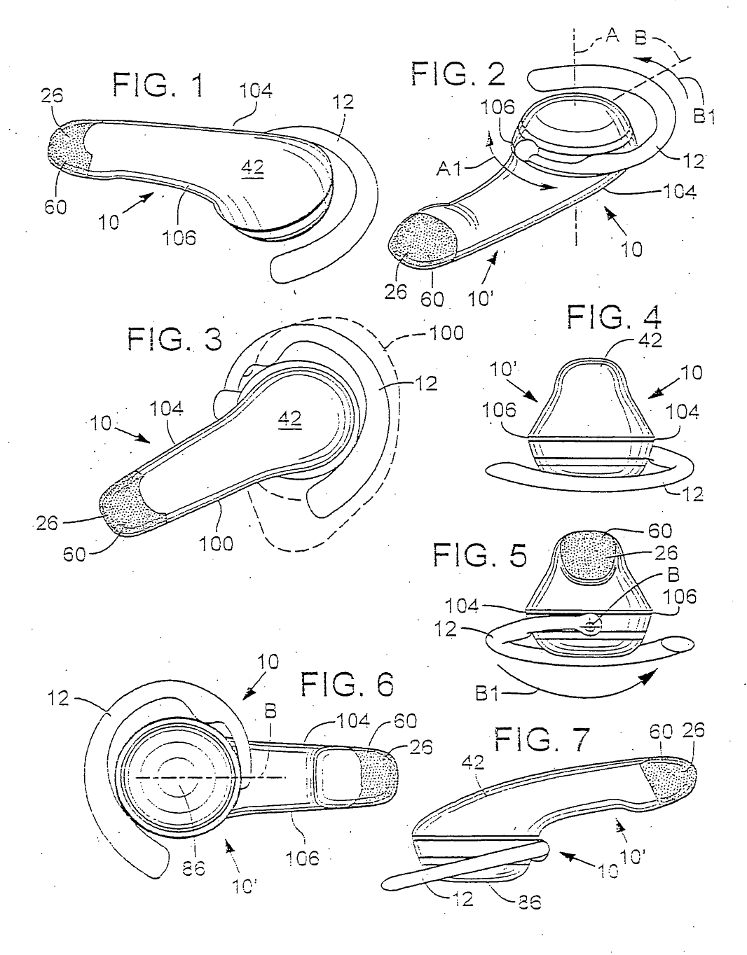

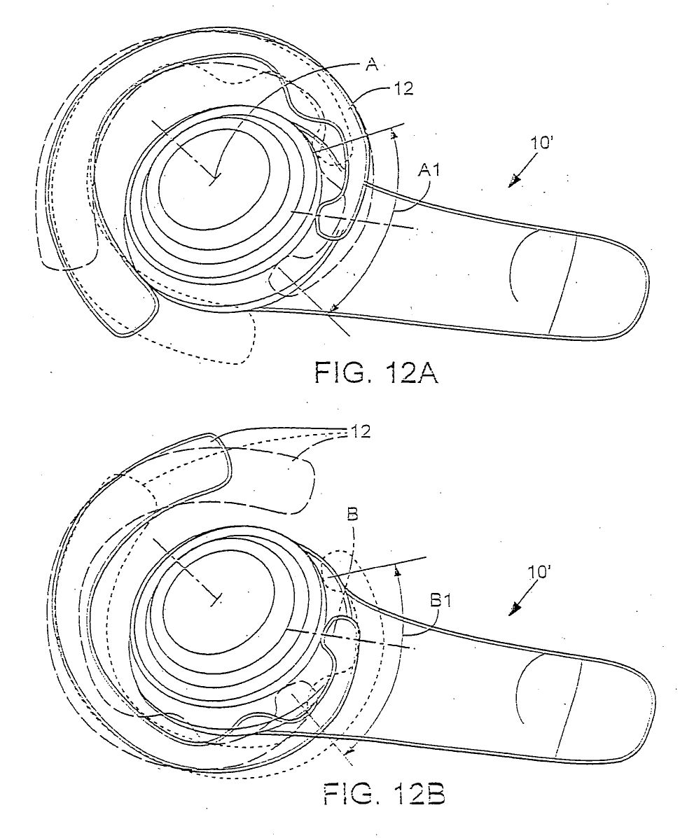

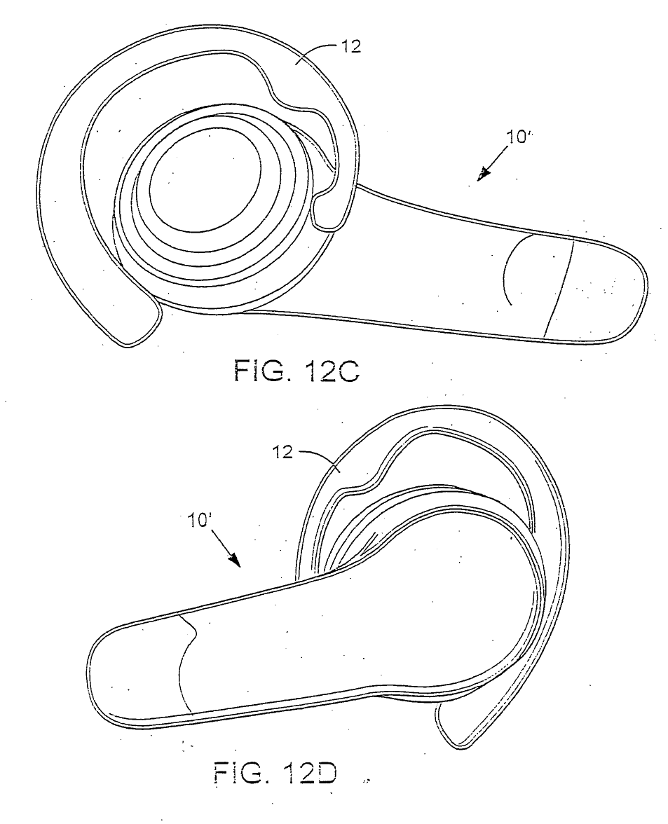

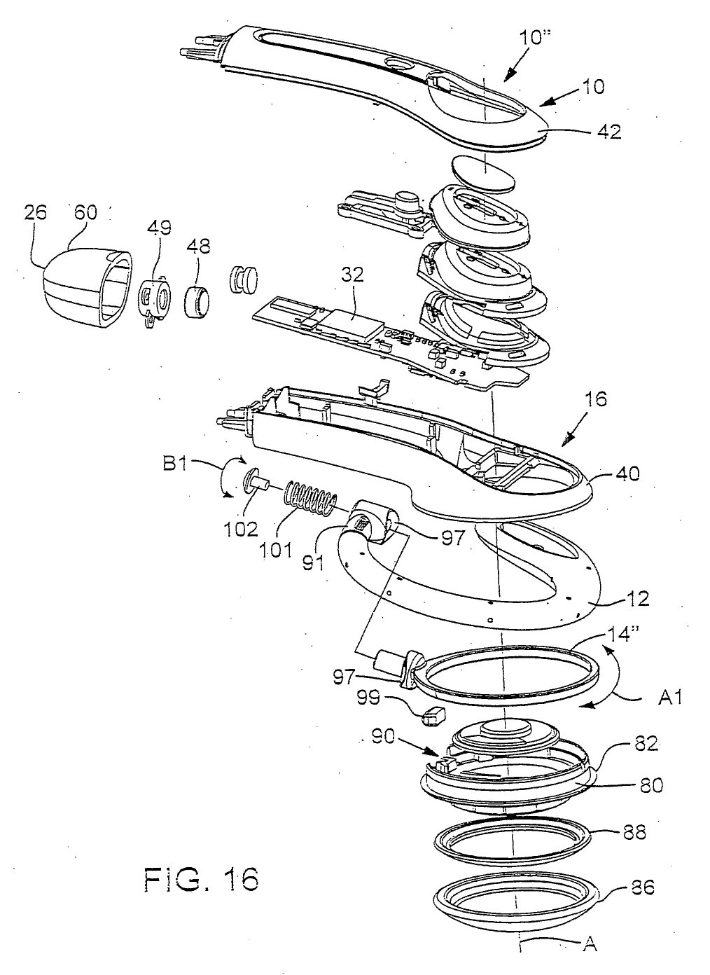

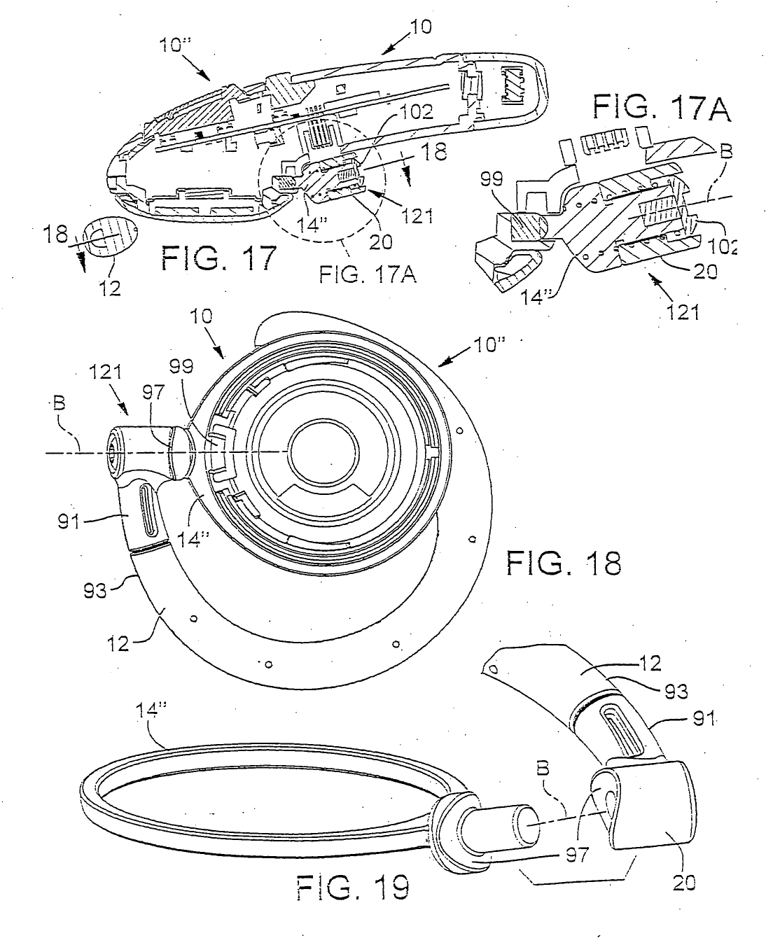

A personal audio set 10, such as a headset, with a porous solid wind screen 60 secured thereto is disclosed in FIGS. 1-19.

A. Exemplar Headset Assemblies

Preferably, the personal audio set 10 is a compact headset 10″ that includes an ear-clip 12 and an ear-clip mounting portion 14 that is slidably secured to a frame 16 so as to preferably slide substantially about a first axis A is disclosed in FIGS. 1-19.

In a preferred embodiment shown in FIGS. 1-12D, the ear clip 12 of the personal audio set 10 is also preferably pivotally secured to the ear-lip mounting portion 14 so as to pivot about a second axis B, and axis A and axis B are preferably aligned substantially orthogonally to each other as best shown in FIG. 2. Even more preferably, axis A is aligned substantially perpendicular to a plane defined by the outer edge of a wearer's ear when the personal audio set is being worn, and axis B is aligned substantially with this plane.

The ear clip 12 is preferably substantially c-shaped so as to mount around the base of a wearer's ear. A first end 20 of the ear clip 12 is pivotally secured to the ear clip mounting portion 14 defining axis B. The ear clip-mounting portion 14 is slidably secured to the frame 16 so as to define axis A.

The frame 16 includes an earphone portion 22 sized and shaped to operably engage a wearer's ear. An optional boom microphone portion 24 preferably extends from the frame 16. If so, it is desirable for the tip 26 of the boom microphone 24 to be either over or directed toward the wearer's mouth (not shown).

The earphone portion 22 preferably contains an earphone 30, and suitable wireless transmitting circuitry 32 is preferably contained within the frame 16 to permit wireless communication with a receiving device. Alternatively, wiring (not shown) extends from the headset 10′ to operably connect the headset 10′ to an appropriate audio device (not shown).

Preferably and as best shown in FIG. 9, the frame 16 includes a base 40 with a cover 42 attached thereto to define an internal chamber 44 for receiving personal audio set electronics 46 and related components such as a microphone 48 and transmitter 50 therein. The base 40 and cover 42 preferably also define the boom microphone portion 24, and the porous solid windscreen 60 is preferably positioned toward or at the tip 26 of the boom microphone portion 24.

The ear clip-engaging portion 14 is preferably a ring 14′ sized to rotate about the mating lip 80 of an engaging structure 82 that is secured to the frame 16. An opposite ear phone mounting portion 84 is connected to the engaging structure 82 so as to allow the ring 14′ to rotate about the lip 80. The earphone-mounting portion 84 preferably includes the earphone 30 therein and a padded cover 86 with a related mounting ring 88.

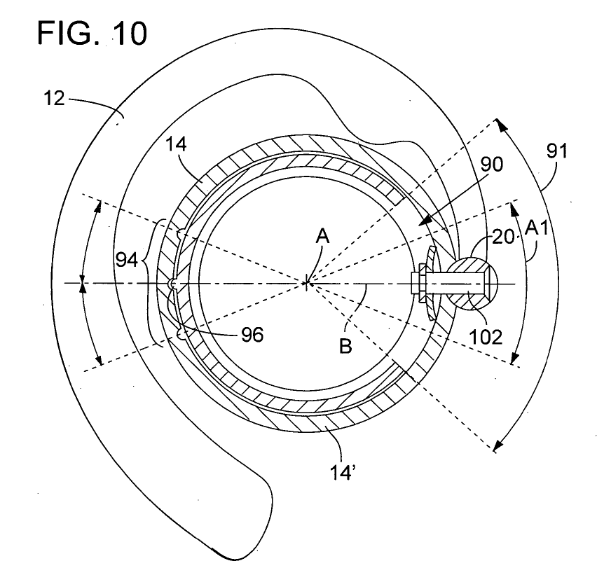

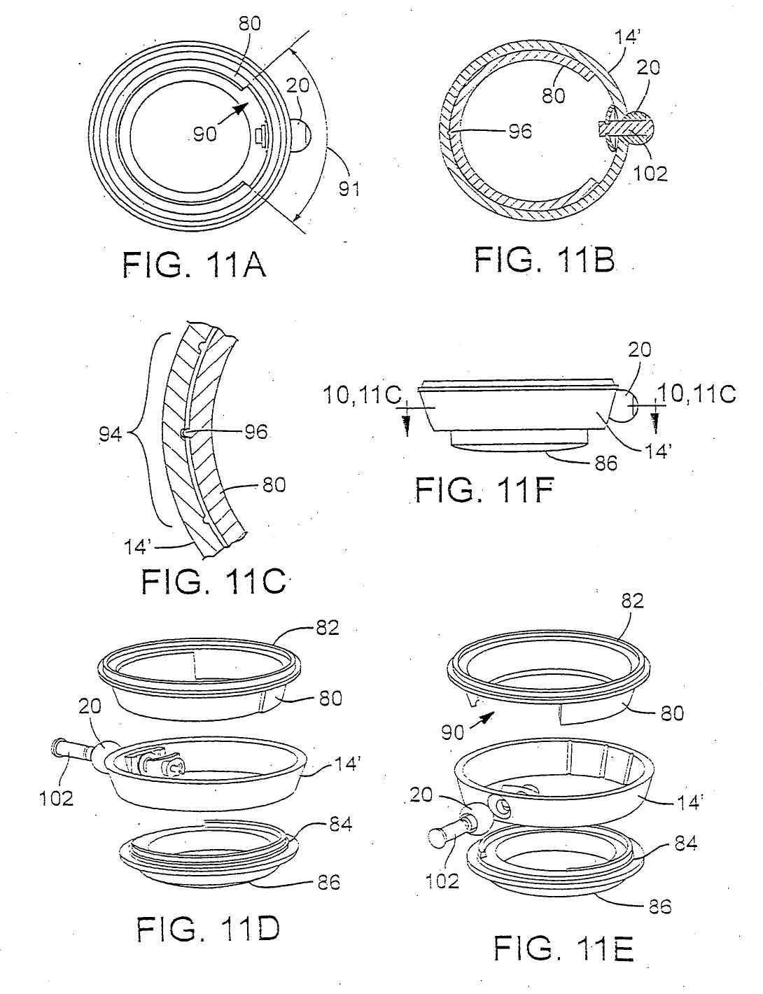

Preferably the engaging structure 82 includes an opening 90 sized to limit the range of movement of the ring 14′. More preferably and as best shown in FIG. 10, this range of movement 91 is about plus or minus 25 degrees from the center 92 of the opening 90. More preferably and as best shown in FIG. 11c, a plurality of spaced-apart, resistive detents 94 are provided along the engaging surfaces between the ring 14′ and lip 80 so as to allow a protrusion 96 extending from the lip 80 to hold the ring 14′ at a desired position relative to the frame 16. Accordingly, a user may position the ear clip 12 relative to the frame 16 along axis A so as to properly align the boom microphone portion 24 and optimize wearer comfort.

Preferably and as shown in FIG. 9, first end 20 of the ear clip 12 is pivotally secured to the ear clip mounting portion 14 with a pivot pin 102, thereby defining pivot axis B and allowing the ear clip 12 to move about pivot axis B in the direction of arrow B1 (FIGS. 2, 7 and 9). More preferably, the ear clip 12 pivots about axis B so as to move, or flip, about the frame 16 and thereby allow the ear clip 12 to be positioned along either the top edge 104 or bottom edge 106 of the frame. Accordingly, the personal audio set may be worn in either the wearer's left or right ears depending on how the ear clip 12 is positioned relative to the frame 16. Preferably, resistive detents are provided between the first end 20 of the ear clip and the ring 14′ so as to hold a desired position of the ear clip 12 about the axis B relative to the frame 16.

Preferably, the ear hook 12 may be formed of a substantially rigid material to essentially define a spine (91, FIG. 15A) of the ear hook, with more pliable, resilient, cushioning materials appended at key positions along the spine. These key locations preferably include positions along the spine where the user's ear and head contact the ear hook. More preferably, these two materials forming the ear hook are dual molded to define the spine 91 (FIG. 15A) and an over-molded more pliable cushioning material 93 (FIG. 15B) that are joined together as best shown in FIG. 15C. Known possible rigid materials for the spine include polycarbonate such as one sold by the General Electric Corporation under the trade name LEXAN EXRL 0050. A possible over-mold material is Silicone Rubber Base, Shore 50A. Of course, other materials could be used as needed.

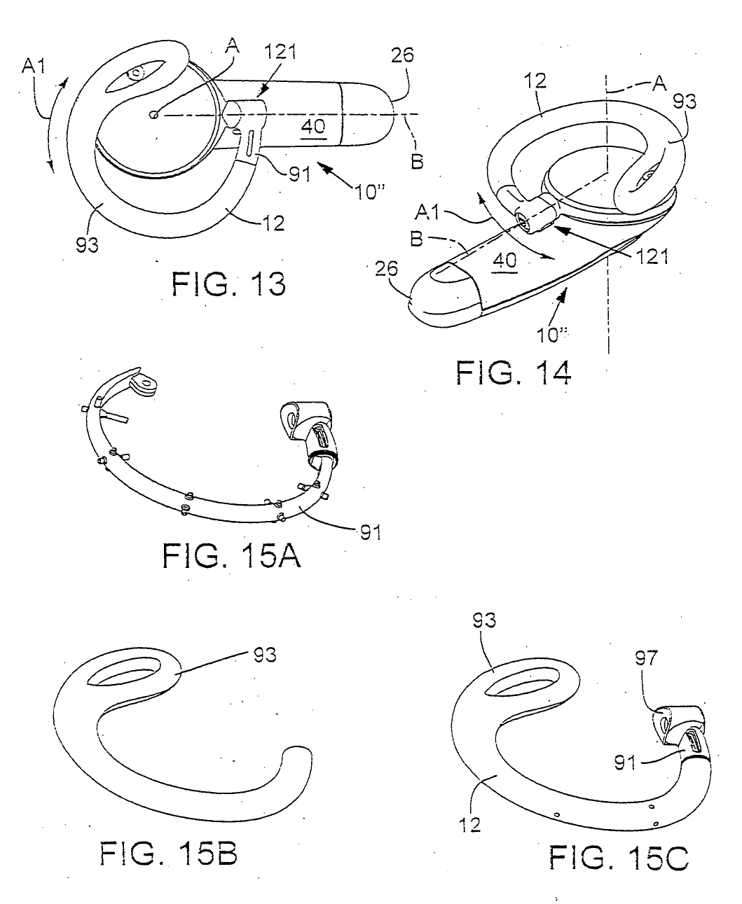

An alternative exemplar headset 10″ assembly is shown in FIGS. 13-19. In order to avoid undue repetition, like elements between the personal audio set 10″ and 10′ are like numbered.

In particular, an alternative preferred pivoting structure 121 for securing the ear hook to the frame is disclosed. The first end 20 of the ear clip 12 is pivotally secured to the ear clip-mounting portion 14 with pin 102. The first end 20 and the ring 14″ both include a smoothly arcuate concave and convex surface 97 as best shown in FIG. 19 that intermesh so as to bias the ear clip to a defined position relative to the frame. More preferably, a biasing force, such as that applied by compression spring 101, urges the ear clip to the defined position which still allowing the ear clip to be positioned and moved as needed to optimize wearer comfort.

More preferably, a friction pad 99 is also operably secured between the ring and sliding surface of the frame so as to resist movement of the ring on the frame after a user as selected a desired position of the ear hook relative to the frame. Accordingly, the ring 14″ can rotate 360 degrees about axis A without the need for resistive detents along the engaging surface.

A user mounts the personal audio set 10 to their ear 100 by positioning the ear clip 12 at a desired location about axis B for so as to allow the clip to fit over and behind either the user's left or right ear with the ear phone 30—positioned substantially adjacent to the ear canal of the user. The user can the adjust the position of the boom microphone portion about axis A by sliding the frame 16 relative to the ear clip 12 substantially about axis A.

B. Porous Solid Wind Screen

The windscreen 60 is formed of a porous solid material such as metal, polymer, plastic or the like thereby avoiding the need for a familiar large foam ball of material over the microphone. Preferably, the windscreen 60 is a monolithic structure formed by sintering the material so as to produce a relatively consistent and desired sized pore structure.

More preferably, the windscreen 60 is sintered while in a mold, thereby allowing it to be formed in a variety of form factors including substantially arcuate structures or non-symmetrical shapes and the like to accommodate desired aesthetic and acoustic needs.

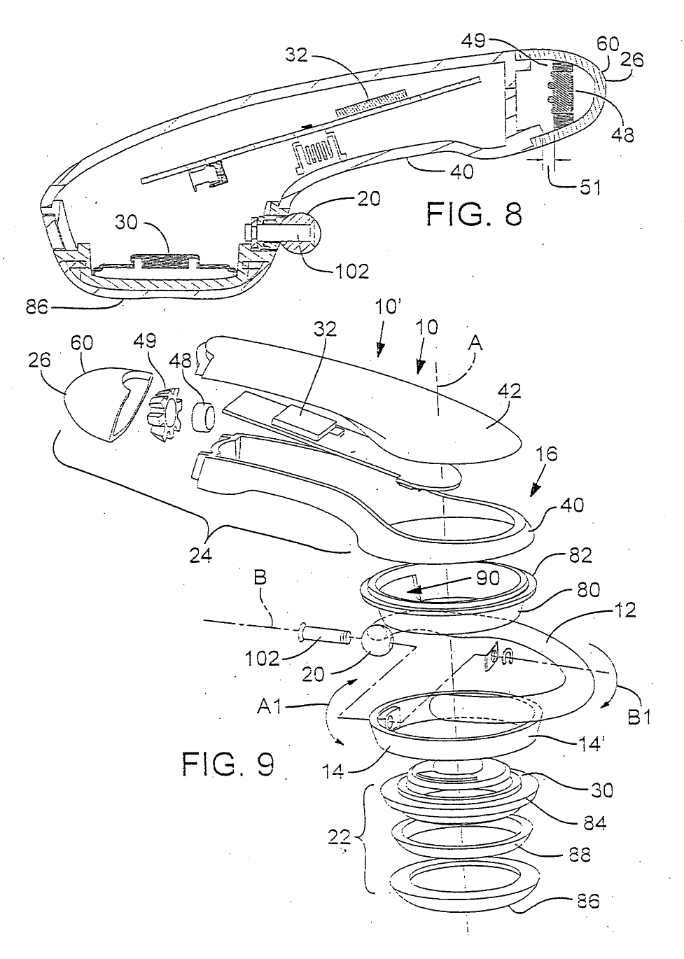

Referring to FIGS. 8 & 16, the windscreen 60 preferably substantially encircles the microphone 48, which is held in place by microphone support 49 preferably having a large number of vents therethrough. Preferably, the windscreen 60 extends over and past the microphone by a defined distance 51 of least 2 millimeters. Because of the acoustic transparency of the porous solid windscreen, the microphone is essentially suspended in substantially acoustic interference free space, thereby improving its sound capture characteristics of desirable sounds.

Preferably, the median pore size and pore volume for the windscreen 60 are optimized for the particular application and material used. For example, when the windscreen is mold formed using high density polyethylene, the median pour size is preferably between 60 microns to 500 microns, inclusive, with a corresponding preferred pore volume of between 35% to 75%, inclusive. More preferably, for headset applications of a windscreen formed of high-density polyethylene, the median pore size is between 75 microns and 125 microns, inclusive, with a more preferred corresponding pore volume of between 40% to 65%, inclusive.

When the windscreen is formed using ultra high molecular weight polyethylene, the median pour size is preferably between 10 microns and 60 microns, inclusive, with a preferred corresponding pore volume of 33% to 70%, inclusive. More preferably, the median pore size is between 10 microns to 40 microns with a corresponding pore volume of between 35% to 60%, inclusive.

The pour size and pore volume can be optimized for the particular anticipated frequency range of the microphone sought to be used with the windscreen. In general, as the median pore size and pore volume change, the effective airflow through the windscreen will change and thus increase or decrease the usable acoustic frequency range. For example, when a larger pore size and corresponding pore volume, a usable acoustic frequency range of between 100 Hz to 10 KHz is achievable with a +/−2 dB tolerance. This frequency range is ideal for applications that require accurate speech recognition and demand higher audio quality. The anticipated wind noise reduction for such a configuration would be in the range of about 15 dBA.

When a smaller pore size and the corresponding pore volume is used, a useable acoustic frequency range of between 300 Hz to 4 Khz is achievable with a +/−2 dB tolerance. This frequency range is ideal for many telecommunications device applications and is indicative of speech quality. The anticipated wind noise reduction for such a configuration would be in the range of about 20 dBA.

If desired, an even more restrictive pore size and pore volume could be used to achieve a usable acoustic frequency range of between 300 Hz to 3 Khz with a +0/−4 Db tolerance. Though this tolerance could be viewed by some as being less than ideal, it offers particular benefits for use with telecommunications devices that use directional microphones and the like. Such applications include wired and wireless headsets with boom microphones, which are particularly susceptible to wind noise and the like. The anticipated wind noise reduction for such a configuration would be in the range of about 33 dBA, which often justifies the comparatively slight reduction in desirable acoustic energy passing through the windscreen.

C. Alternative Embodiments

Having described and illustrated the principles of our invention with reference to a preferred embodiment thereof, it will be apparent that the invention can be modified in arrangement and detail without departing from such principles. For example, although two exemplar headset assemblies have been described, the features of the porous windscreen can be applied to any microphones, whether or not the microphone is attached to a headset. Also, the median pore size and pore volume can vary within a wind screen so as to optimize the structure even further based on the geometry of the screen relative to the location of the microphone.

In view of the many possible embodiments to which the principles may be put, it should be recognized that the detailed embodiment is illustrative only and should not be taken as limiting the scope of our invention. Accordingly, we claim as our invention all such modifications as may come within the scope and spirit of the following claims and equivalents thereto.

We claim:

1. A headset having:
a frame;
an earphone operably secured to the frame;
a microphone operably secured to the frame; and,
an asymmetrical, porous solid windscreen covering said microphone.

2. The headset of claim 1, wherein said asymmetrical, porous solid windscreen is spaced apart from said microphone by a defined distance.

3. The headset of claim 2, wherein said defined distance is at least 2 millimeters.

4. The headset of claim 1, where said asymmetrical, porous solid windscreen is formed by sintering material together in a mold.

5. A headset having:
a frame;
an earphone operably secured to the frame;
a microphone operably secured to the frame; and,
a porous solid windscreen covering said microphone, the porous solid windscreen having a median pore size between 10 to 500 microns, inclusive with a corresponding pore volume of between 33% to 75%, inclusive.

6. The headset of claim 5, wherein said porous solid windscreen has a median pore size between 10 microns to 60 microns, inclusive.

7. The headset of claim 6, wherein said porous solid windscreen has a median pore size between 10 microns and said 40 microns, inclusive.

8. The headset of claim 5, wherein said porous solid windscreen has a median pore size between 60 microns to 500 microns, inclusive.

9. The headset of claim 5, wherein said porous solid windscreen has a median pore size between 75 microns to 125 microns, inclusive.

10. The headset of claim 5, wherein said porous solid windscreen has a pore volume of between 35% to 75%, inclusive.

11. The headset of claim 10, wherein said porous solid windscreen has a pore volume of between 40% to 65%, inclusive.

12. The headset of claim 5, wherein said porous solid windscreen has a pore volume of between 33% to 70%, inclusive.

13. The headset of claim 12, wherein said porous solid windscreen has a pore volume of between 35% to 60%, inclusive.

14. A molded, porous windscreen for a microphone having:
a median pore size between 10 to 500 microns, inclusive with a corresponding pore volume of between 33% to 75%, inclusive.

15. The molded, porous windscreen for a microphone of claim 14, wherein said windscreen is spaced apart from the microphone by a defined distance of at least 2 millimeters.

16. The molded, porous windscreen for a microphone of claim 14, further including a headset and said microphone is a directional microphone.

17. The molded, porous windscreen for a microphone of claim 14, wherein said windscreen is non-symmetrical.

18. The molded, porous windscreen for a microphone of claim 14, wherein the windscreen is formed of high-density polyethylene.

19. The molded, porous windscreen for covering a microphone of claim 14, wherein said windscreen is formed of ultra high molecular weight polyethylene.
